(19) United States
(12) Patent Application Publication
(10) Pub. No.: US 2008/0117320 A1
(43) Pub. Date: May 22, 2008

(54) Imaging apparatus that is connectable to and controlled by a separate apparatus

(75) Inventors: Masao Onuki, Matida-shi (JP); Akira Ohmura, Kawasaki-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/007,667

(22) Filed: Jan. 14, 2008

Related U.S. Application Data
(63) Continuation of application No. 10/875,813, filed on Jun. 25, 2004, now abandoned.
Application No. 10/875,813 is a continuation of application No. 09/912,550, filed on Jul. 26, 2001, now abandoned.
Application No. 09/912,550 is a continuation of application No. 08/900,448, filed on Jul. 25, 1997, now abandoned.

(30) Foreign Application Priority Data
Aug. 13, 1996 (JP) 08-213494

(51) Int. Cl. H04N 5/335; H04N 5/222

(52) U.S. Cl. 348/294; 348/333.01; 348/E05.022; 348/E05.091

(57) ABSTRACT

An imaging apparatus includes a connector that is directly connectable to a bus of an information processing apparatus that is separate from the imaging apparatus. This enables the set-up of the various parameters of the imaging apparatus to be performed rapidly while the imaging apparatus is directly electrically connected to the bus of the information processing apparatus, which can be, for example, a personal computer. The connector is coupled to a controller of the imaging apparatus. The imaging apparatus can also include a photographic lens and a photoelectric converter arranged relative to the photographic lens to receive light focused by the photographic lens. The photoelectric converter outputs an image signal of an object based on the image formed by the photographic lens. The controller is coupled to the photoelectric converter to control the imaging apparatus. According to one embodiment, the connector is a Personal Computer Memory Card International Association-conforming connection terminal.

This is a Continuation of application Ser. No. 10/875,813 filed Jun. 25, 2004, which in turn is a Continuation of application Ser. No. 09/912,550 filed Jul. 26, 2001, which in turn is a Continuation of application Ser. No. 08/900,448 filed Jul. 25, 1997. The entire disclosure of the prior applications is hereby incorporated by reference herein in their entirety.

### INCORPORATION BY REFERENCE

The disclosure of the following priority application is herein incorporated by reference: Japanese Patent Application No. 8-213494.

### BACKGROUND OF THE INVENTION

1. Field of the Invention

The present invention relates to an imaging apparatus, and relates in particular to an imaging apparatus that can be attached in an electrically connective manner to a prescribed information processing apparatus so that the information processing apparatus can change set-up parameters used by the imaging apparatus.

2. Description of Related Art

In conjunction with the progress that has been made in information processing technology, electronic cameras have been developed that electrically photograph objects using a photoelectric conversion element such as, e.g., a CCD (Charge Coupled Device). Some of these electronic cameras include a serial interface, such as an RS232C interface, for example, and can be connected to the serial port and the like of a personal computer (PC), via a prescribed cable.

There are also electronic cameras having an SCSI (Small Computer System Interface), which connects to the SCSI of a personal computer via a prescribed cable.

When the electronic camera is connected to a personal computer, it is possible to perform set-up (i.e., assign values to the parameters used by the electronic camera) of the electronic camera by user operation of the personal computer.

However, in the electronic camera described above, when set-up of the various functions of the electronic camera is performed by operating the personal computer, set-up of the various functions is performed via a serial interface. As a result, problems exist in that the communication speed between the personal computer and the electronic camera is slow. Accordingly, a great deal of time is required to set-up the various functions, which is inconvenient.

Use of an SCSI interface provides high speed communication between the personal computer and the electronic camera. However, it is necessary for the power source of the personal computer to be OFF when connecting the personal computer and the electronic camera. Therefore, to perform the communication between the personal computer and the camera-main body, the power source of the personal computer first has to be turned OFF. Then the PC and camera have to be connected, and then the personal computer must again be restarted. Accordingly, a fair amount of time is expended in the connection operation.

It is also recommended that the personal computer power source be turned OFF when connecting the PC serial interface, described above, to the electronic camera, which similarly expends a fair amount of time in the connection operation.

### SUMMARY OF THE INVENTION

In view of the problems described above, one aspect of the invention relates to an imaging apparatus (for example, an electronic camera) that enables the set-up of the various parameters of the imaging apparatus to be performed rapidly while the imaging apparatus is directly electrically connected to the bus of an information processing apparatus such as, for example, a personal computer.

An imaging apparatus that incorporates this aspect of the invention includes a connector that is directly connectable to a bus of an information processing apparatus that is separate from the imaging apparatus. The connector is coupled to a controller of the imaging apparatus. The imaging apparatus can also include a photographic lens and a photoelectric converter arranged relative to the photographic lens to receive light focused by the photographic lens. The photoelectric converter outputs an image signal of an object based on the image formed by the photographic lens. The controller is coupled to the photoelectric converter to control the imaging apparatus.

According to one embodiment, the connector is a Personal Computer Memory Card International Association-conforming connection terminal.

The controller controls the imaging apparatus according to set-up parameters, and the set-up parameters are set to values provided from the information processing apparatus through the connector. For example, the set-up parameters set imaging conditions of the imaging apparatus.

When the apparatus is an electronic camera, the photographic lens, the photoelectric converter and the controller are located in an outer casing of the electronic camera, and the connector is provided on the outer casing of the electronic camera.

### BRIEF DESCRIPTION OF THE DRAWINGS

The invention will be described in conjunction with the following drawings in which like reference numerals designate like elements and wherein:

FIG. 1 is a perspective view of an electronic camera according to an embodiment of the present invention;

FIG. 2 is a perspective view of the electronic camera of FIG. 1 connected to a personal computer;

FIG. 3 is a perspective view showing one example of a possible internal construction of the FIG. 1 electronic camera; and

FIG. 4 is a block diagram of one possible construction of the electrical components of the FIG. 1 electronic camera.

### DETAILED DESCRIPTION OF PREFERRED EMBODIMENTS

Embodiments of the present invention are described below with reference to the drawings.

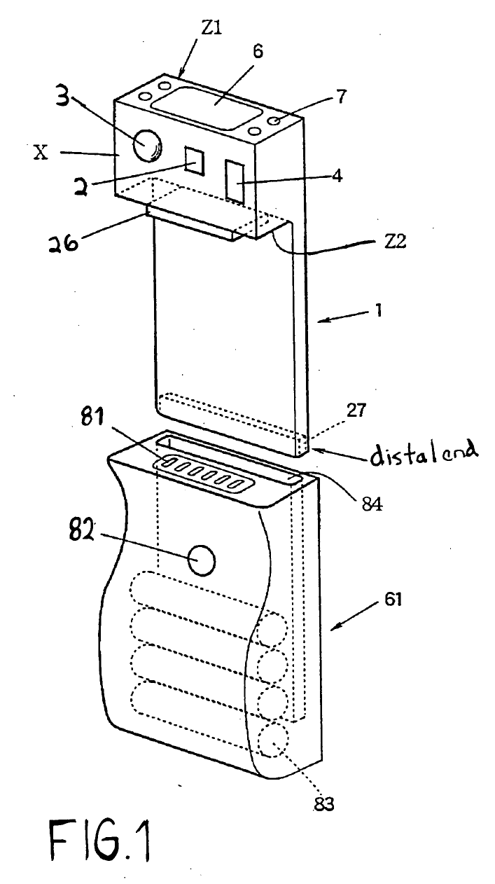

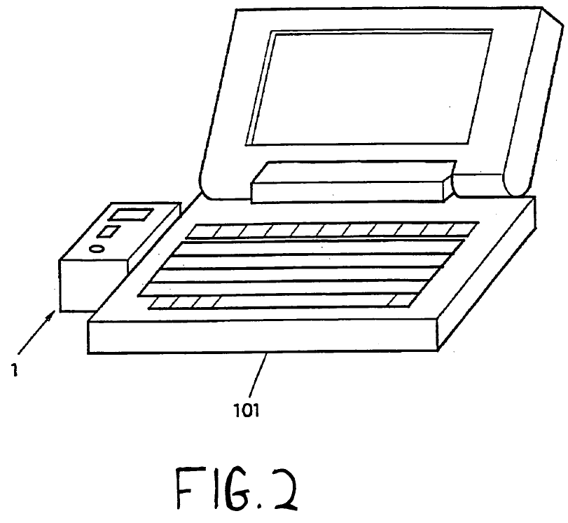

Referring to FIG. 1, an electronic camera 1 performs photography of objects while it is connected to a holder 61. Holder 61 includes one or more batteries 83 (i.e., a power source) that supply power to a release button 82 that is operated during photography, and to each electronic circuit. As shown in FIG. 2, the electronic camera 1 can be connected to a designated expansion slot of the personal computer 101, through which camera 1 retrieves signals that correspond to operations performed in the personal computer 101. Various parameters (such as, for example, the compression rate of the data of the photographed image) are set based on the retrieved signals.

Referring again to FIG. 1, a viewfinder 2, a photographic lens 3 and a strobe 4 are arranged on the surface X, which is the surface of the electronic camera 1 that faces the object during photography. The viewfinder 2 displays the photographic range of the object to be photographed to the user. The photographic lens 3 collects light of the light image of the object. The strobe 4 flashes light to illuminate the object.

An LCD 6 that displays the photographed image and one or more operation keys 7 to which various operations are performed by the user are arranged in the surface Z1, which is the top surface of the electronic camera 1.

A first connector 26 is arranged on the surface Z2, which is the bottom surface of the electronic camera 1. Connector 26 attaches the holder 61 to the electronic camera 1 when the distal end part of the electronic camera 1 is inserted into the hole 84 of the holder 61. Once inserted, the first connector 26 becomes connected to the first connector 81 of the holder 61. Power from the batteries 83 and a signal corresponding to the operation of the release button 82 are supplied to the electronic camera 1 from the holder 61 via the first connector 26 and the first connector 81.

A second connector 27 is arranged at the distal end part of the electronic camera 1. The second connector 27 is, for example, a PCMCIA (Personal Computer Memory Card International Association)-conforming connecting terminal, and can be connected to the connecting terminal (that is, the bus) of the expansion slot of the personal computer 101. Power for the internal electronic circuits of camera 1 and the values for setting the parameters of camera 1 are supplied to the electronic camera 1 from the personal computer 101 via the second connector 27.

When the electronic camera 1 is connected to the holder 61 (via first connectors 26 and 81), there is nothing electrically connected to the second connector 27. Conversely, when the electronic camera 1 is connected to the personal computer 101 (via second connector 27 and the PC expansion slot), there is nothing electrically connected to the first connector 26.

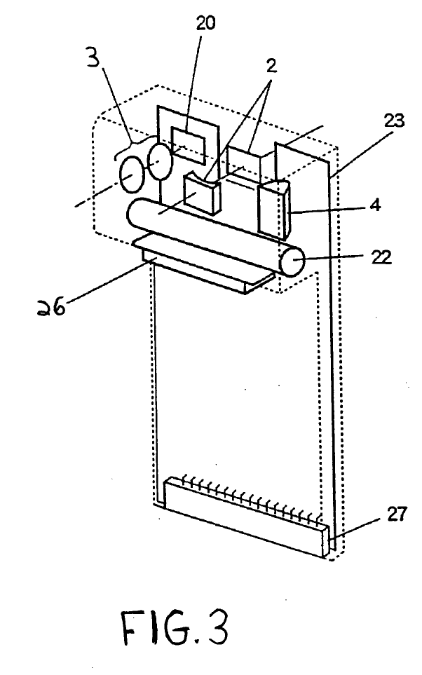

Next, referring to FIG. 3, one possible construction of the internal parts of the electronic camera 1 is described. A CCD (Charge Coupled Device) 20 is provided behind the photographic lens 3, so that the light image of the object focused by the photographic lens 3 is photoelectrically converted into an electric signal. Photoelectric conversion devices other than a CCD can be used with the invention.

A condenser (or capacitor) 22 accumulates charge for outputting a flash of light by the strobe 4. Condenser 22 is arranged vertically below the viewfinder 2, the photographic lens 3 and the strobe 4.

Various control circuits can be formed in a circuit board 23 to control each part of the electronic camera 1. A flash memory 24 (explained later) is provided in the circuit board 23. The data of the photographed image, various parameters, and the like can be stored in the flash memory 24.

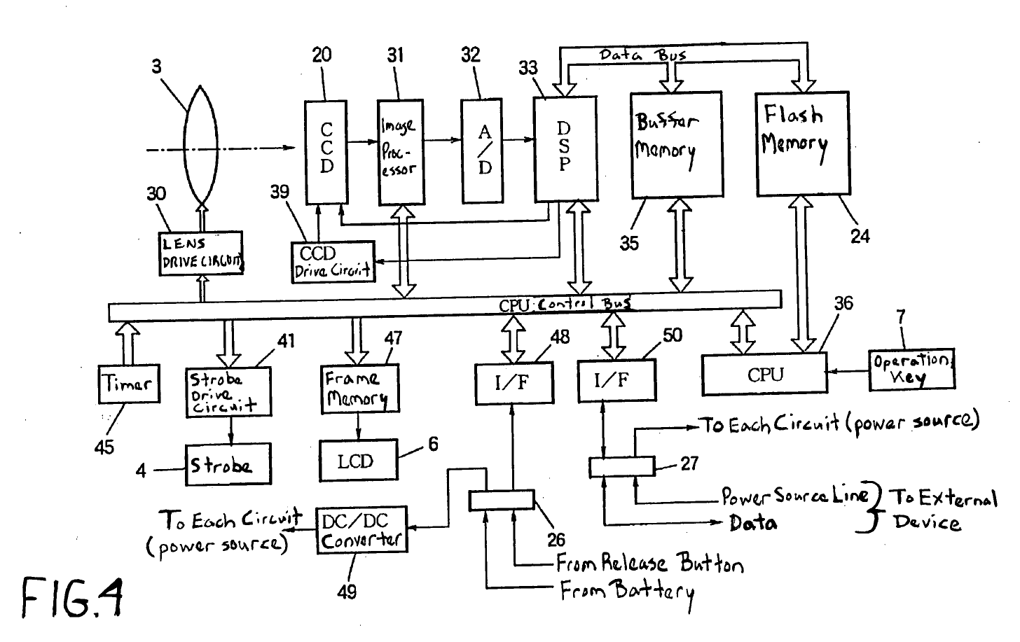

Next, one possible electrical construction of the internal parts of the electronic camera 1 of this embodiment is explained with reference to the block diagram of FIG. 4. The CCD 20, which includes a plurality of pixels, photoelectrically converts the light images focused onto each pixel into image signals (electric signals). A digital signal processor (referred to below as a DSP) 33 supplies a CCD horizontal drive pulse to the CCD 20. DSP 33 also controls the CCD drive circuit 39 and supplies a CCD vertical drive pulse to the CCD 20.

An image processor 31 is controlled by a CPU 36, and samples in a prescribed timing the image signals photoelectrically converted by the CCD 20. An analog-to-digital converter (A/D converter) 32 digitizes the image signals sampled by the image processor 31, and supplies the digitized signals to the DSP 33.

The DSP 33 controls the data bus connected to the buffer memory 35 and the flash memory 24. In particular, after the image data supplied from the A/D converter 32 is temporarily stored in the buffer memory 35, the image data stored in the buffer memory 35 is read out and then recorded in the flash memory 24.

The DSP 33 also can store the image data supplied from the A/D converter 32 in the frame memory 47, whereupon the image data is displayed on the LCD 6. In conjunction with this process, the DSP 33 can read out the image data stored in the flash memory 24 and store this image data in the frame memory 47, to be displayed on the LCD 6.

The buffer memory 35 is used to harmonize any differences that occur between the input/output speed of data with respect to the flash memory 24, and the processing speed in the CPU 36, the DSP 33 and the like.

The flash memory 24 includes a nonvolatile memory component, and stores setting parameters for the various functions in addition to the image data of the photographed image.

The CPU 36 writes the signals (e.g., the setting parameters) supplied from the personal computer 101 via the second connector 27 and an interface (I/F) 50 to a prescribed region of the flash memory 24.

The CPU 36 also outputs image data stored in the flash memory 24 to the personal computer 101 via the I/F 50 and the second connector 27.

In addition to controlling the strobe drive circuit 41, which causes the appropriate amount of light to be flashed by the strobe 4, CPU 36 also controls the lens drive circuit 30 to perform an autofocus operation by moving the photographic lens 3.

The CPU 36 also retrieves signals from the operation keys 7, which can include, for example, a power source switch, and processes these signals in an appropriate manner.

A backup battery is provided in a timer 45, which outputs data indicating the current moment in time to the CPU 36.

When the electronic camera 1 is connected to the holder 61, an interface (I/F) 48 outputs signals from the release button 82, that are supplied via the first connector 26 from the holder 61, to the CPU 36.

When the electronic camera 1 is connected to the holder 61, a DC/DC converter 49 converts the voltage supplied from the batteries 83 connected via the first connector 26 to the appropriate operating voltage for each circuit provided in the electronic camera 1, and supplies that voltage to each circuit.

When the electronic camera 1 is connected to the personal computer 101, the I/F 50 outputs signals supplied via the second connector 27 from the personal computer 101 to the CPU 36. Additionally, when the electronic camera 1 is connected to the personal computer 101, the second connector 27 supplies power from the personal computer 101 to each circuit.

Next, various operations of the electronic camera 1 of this embodiment are explained. First, the shooting operation of the electronic camera 1 will be described.

Initially, after the distal end of the electronic camera 1 is inserted into the hole 84 of the holder 61 to connect the electronic camera 1 to the holder 61, the power source switch, which is one of the operation keys 7, is operated, to supply power to the electronic camera 1. In other words, the camera is turned ON. The object is confirmed by the user through the viewfinder 2, and when the release button 82 of the holder 61 is pressed, the process of photographing the object begins.

The light image of the object observed through the viewfinder 2 is focused by the photographic lens 3 onto the CCD 20, which includes a plurality of pixels. The light image of the object formed on the CCD 20 is photoelectrically converted into image signals by each pixel, and sampled by the image processor 31. The image signals sampled by the image processor 31 are supplied to the A/D converter 32, and are then digitized and output to the DSP 33.

The DSP 33, after outputting that image data to the buffer memory 35 where it is temporarily stored, reads out that image data from the buffer memory 35, and stores that image data in the flash memory 24.

At this time, the DSP 33 preferably compresses the image data according to the JPEG (Joint Photographic Experts Group) method, which combines discrete cosine transformation, quantization and Huffman encoding. Thus, compressed images are stored in the flash memory 24. Other compression techniques could be used.

When the release button 82 is continuously pressed, the DSP 33 outputs the image data obtained during that time to the frame memory 47, and the photographed image is displayed on the LCD 6.

Further, it is also possible to operate the strobe 4 as needed to illuminate the object with light.

When the electronic camera is connected to the personal computer 101, it is also possible to perform the shooting (photographing) operation by operating the personal computer 101.

Next, an operation in which the parameters in the electronic camera 1 are changed will be explained.

Initially, as shown in FIG. 2, the distal end (including the second connector 27) of the electronic camera 1 is inserted into the expansion slot of the personal computer 101 to connect the electronic camera 1 and the personal computer 101. When a designated operation in the personal computer 101 is performed by the user, a signal corresponding to this operation is output to the electronic camera 1 via the bus within the personal computer 101 and the expansion slot. One example of a designated operation is an operation in which the compression rate is set for compressing the data to be stored in the flash memory.

The electronic camera 1 retrieves this signal via the I/F 50 and the second connector 27. The I/F 50 also outputs this signal to the CPU 36. The CPU 36 writes the values of the parameters corresponding to this signal into the particular region of the flash memory 24 in which the parameters are stored.

By this process, it is possible to rapidly perform set-up (that is, set-up of the various kinds of functions of the electronic camera 1) of the parameter values because signals setting the parameter values are directly supplied from the bus of the personal computer 101 to the CPU control bus of the camera 1. Some examples of parameter value settings that can be performed include the setting of the compression rate of the image signals for the compression process performed by the DSP 33, the strobe 4 operation setting, and the autofocus operation setting.

Although in this embodiment the electronic camera 1 and the personal computer 101 are connected to each other by inserting the distal end part of the electronic camera 1 into the personal computer 101, there is no particular limit as to the connecting method. Connectors other than a PCMCIA—conforming connector can be used with the invention.

As described above, according to an imaging apparatus of the invention, prescribed parameters are set to a value supplied via connectors that are connected directly and electrically to the bus of a designated information processing apparatus (e.g., a PC). As a result, it is possible to rapidly perform set-up of the various functions without having to turn OFF the power source of the information processing apparatus when connecting the imaging apparatus and the information processing apparatus to each other.

While this invention has been described in conjunction with specific embodiments thereof, it is evident that many alternatives modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed:

1. An electronic camera, comprising:
a first unit including:
an imaging device that converts image data formed by a photographic lens into digital data; and
a displaying device that displays the photographed image; and
a second unit including:
a release button that is operated during photography; and
a battery loading space in which one or more batteries may be arranged.

2. An electronic camera according to claim 1, wherein the first unit further includes an illuminating device that illuminates an object to be photographed.

3. An electronic camera according to claim 1, wherein the first unit is movable relative to the second unit.

4. An electronic camera, comprising:
a first module including:
a photoelectric converter that converts image data formed by a photographic lens into digital data; and
a display that displays the photographed image; and
a second module including:
a release button that is operated during photography; and
a battery loading space in which one or more batteries may be arranged.

5. An electronic camera according to claim 4, wherein the first module further includes a strobe light that illuminates an object to be photographed.

6. An electronic camera according to claim 4, wherein the first module is movable relative to the second module.
